(19) United States
(12) Patent Application Publication
(10) Pub. No.: US 2008/0168729 A1
(43) Pub. Date: Jul. 17, 2008

(54) Transitions having disparate surfaces

(75) Inventors: Dan Brunedal, Goteborg (SE); Patrick Smith, Raleigh, NC (US)

Correspondence Address: NOVAK, DRUCE + QUIGG L.L.P., 1300 Eye Street, N.W., 1000 West Tower, Washington, DC, 20005, US

(73) Assignee: Pfleiderer Schweiz AG, Zug (CH)

(21) Appl. No.: 11/907,965

(22) Filed: Oct. 18, 2007

Related U.S. Application Data
(60) Provisional application No. 60/852,418, filed on Oct. 18, 2006.

(51) Int. Cl. E04F 19/06; E04B 1/68; B44F 9/00

(52) U.S. Cl. 52/312; 52/464; 52/470

(57) ABSTRACT

A structure to form flooring transitions having outer surfaces comprising two disparate materials. In a preferred embodiment the flooring transitions includes a T-shaped molding and at least one attachment thereto. The outer surfaces of the T-molding and attachment may be comprised of different materials, even though they may sometimes have the same pattern or décor. For example, the T-molding may have a surface of real wood or veneer and the attachment may have an outer surface of abrasion resistant foil, metal, or even a visual perception element, such as lights or reflective tape. A kit is also disclosed.

### CROSS REFERENCE TO RELATED APPLICATIONS

This application claims benefit under 35 U.S.C. 119 of U.S. Provisional Application Ser. No. 60/852,418 filed Oct. 18, 2006, the entire disclosure of which are hereby incorporated by reference its entirety.

### BACKGROUND

1. Field of the Invention

The invention relates to a structure which can be used to form flooring transitions such as T-moldings, hard surface reducers and end moldings, between or adjacent to flooring elements, comprising at least two different materials on the decorative outer surfaces.

2. Background of the Invention

Multifunctional moldings for floors are known in the art, such as described by U.S. Pat. No. 6,860,074, the entire disclosure of which is herein incorporated by reference. Typically, such multifunctional moldings include a first molding element, generally a T-molding, and a second molding element. The first molding element and second molding element are typically connected by a tongue-and-groove joint, adhesive or other mechanical means. Due to the size and shape of the second molding element, when the second molding element is joined to the first molding, element, the assembly forms, for example, a carpet reducer/end molding (sometimes referred to in the art as a “square nose” molding), a hard surface reducer, or a stair nose.

According to one embodiment the present invention the decorative outer surface of the first molding element (or T-molding) is a wood veneer and the decorative outer surface of the other structures, typically the second molding element, is a foil. While foils typically have abrasion resistances substantially less than similar veneer constructions, because the decorative outer surface of the attached molding piece is not subject to significant abrasion due to its shape and position, the present inventors have discovered that when the T-molding is formed from wood veneer, the decorative outer surface of the second molding element can be, instead of a similar wood veneer, a foil. Such a construction reduces cost upwards of 20% when compared to all veneer products.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 shows the assembly of the invention, including both a carpet reducer/end molding and a hard surface reducer.

FIG. 2 shows the assembly of the invention, including a stair nose.

FIG. 3 shows a schematic of a shim and securing element of the invention.

FIG. 4 shows an alternative embodiment of the invention, including a stair nose.

### DETAILED DESCRIPTION OF THE PREFERRED EMBODIMENTS

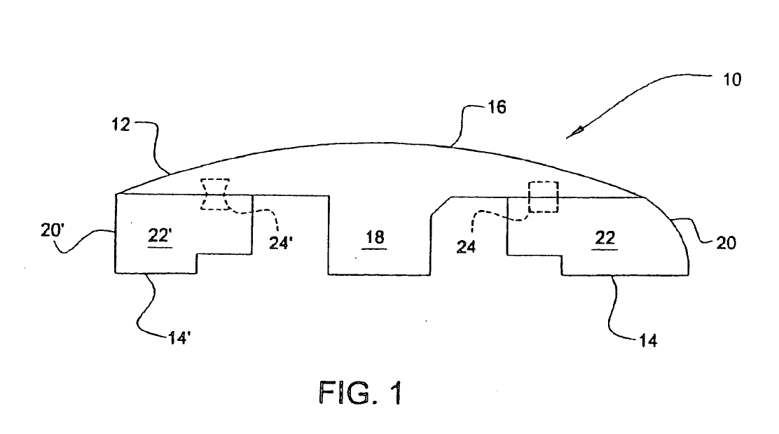

FIG. 1 shows an assembled view of the various parts of the inventive joint cover assembly 10. The assembly 10 includes a T-molding 12. As the overall shape of the T-molding 12 is conventional in the art, and can be readily understood by those of ordinary skill in the art from the drawings, further description is not provided herein.

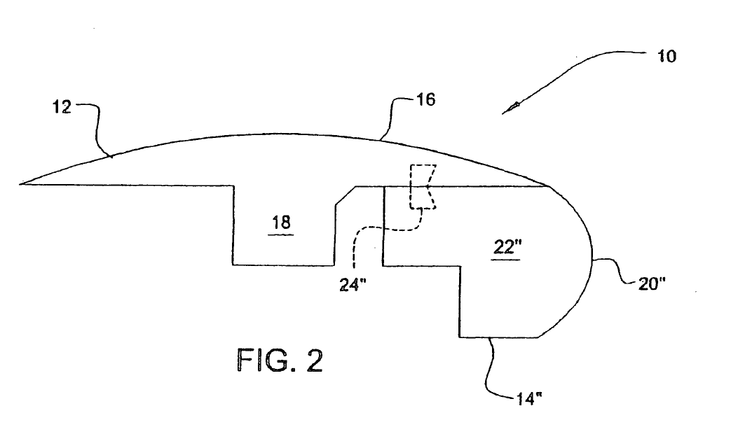

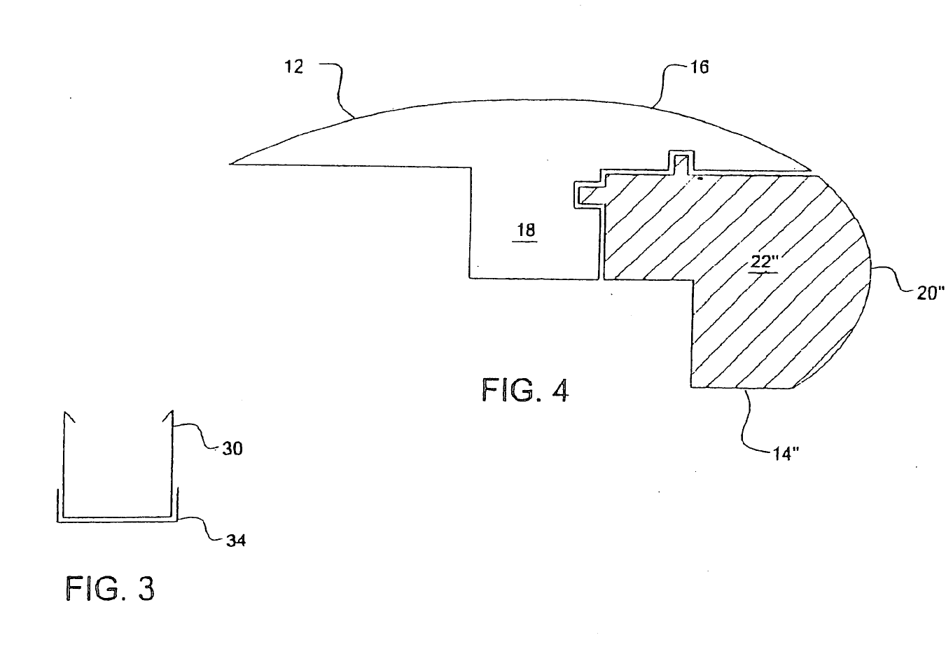

The T-molding 12 is shown as being attached to two second molding elements, or attachments, specifically a hard surface attachment (HSA) 14 and an end molding/carpet attachment (EM) 14′. FIG. 2 (or the alternative embodiment of FIG. 4) shows the T-molding being attached to a different attachment, a stair nose attachment 14″. Depending upon the desired functionality of the assembly, the T-molding 12 can be used with HSA 14, EM 14′ and/or stair nose attachment 14″ (collectively referred to herein as “attachments”). Because the attachments differ only in size and shape, for purposes of clarity only HSA 14 is discussed herein, but it should be understood that any discussion of HSA 14 is equally applicable to EM 14′ and stair nose attachment 20″ and the respective sub-elements as well. When installed, the assembly 10 may also include a securing element 30 to fasten the assembly 10 to a subfloor 32 (not shown) as well as one or more shims 34; see FIG. 3.

The attachments are typically joined to the T-molding via a joint 24. This mechanical joint can be a straight tongue-and-groove joint 24, a dove-tail joint 24′, a half-dove tail joint 24″ or any other type of mechanical joint. As the relative orientation of the joint, i.e., particular location of the tongue and groove, can be on either the T-molding 12 or the attachment, the joints 24 are shown as dotted lines to show that the locations of the tongue and groove can be inverted. However, it is considered within the scope of the invention to eliminate the mechanical joint 24 in favor of a chemical joint, e.g., adhesive, or using the securing element 30 as described by U.S. Pat. No. 6,860,074.

Each of the T-molding 12 and the attachments, i.e., the structural elements of the invention, are formed from a decorative surface (16 and 20, respectively) atop a core (18 and 22, respectively). As can be understood by the drawings, the T-molding 12 of the invention can have two arms or members extending substantially perpendicularly from a substantially downwardly extending foot. To install the T-molding 12, the foot is inserted into the securing element 30, with optionally the shim 34 positioned therebetween. The securing element 30, which may take the form of a clip, track or rail, can be secured to the subfloor by, for example, a screw, nail or adhesive. When installed, the assembly can accommodate flooring systems of a wide variety of heights, for example, on the order of between approximately 3 and approximately 30 mm, typically between approximately 5 and approximately 25 mm, more typically between approximately 10 and 25 mm, and most preferably between approximately 14 mm and approximately 20 mm.

The cores 18 and 22 typically include wood based products, such as high density fiberboard (HDF), medium density fiberboard (MDF), particleboard, strandboard, plywood, gypsum, high density fiber-reinforced plaster, and solid wood; polymer-based products, such as polyvinyl chloride (PVC), thermoplastics or thermosetting plastics or mixtures of plastic and other products, including reinforcements; and metals, such as aluminum, stainless steel, brass, aluminum or copper. The cores 18 and 22 do not necessarily have to be formed of the same material, although in some embodiments they are. For example, although cores 18 and 22 may each be formed of fiberboard, core 18 can be formed of metal and core 22 formed of wood, fiberboard or other wood based product or even plastic. It is to be understood that the surface 16 of the T-molding can sometimes be the top of the core material, such as metal and yet the surface 20 and 20′ can be foil, veneer or laminate, or vice versa, that is to say the surface 16 may be a veneer or laminate and the surface 20 and 21′, which may be the same or different, be formed of a metal, an abrasion resistant foil, laminate, veneer or natural wood.

According to another embodiment of the invention, the surface 16 is a veneer, such as a wood veneer, being one or more thin layers of natural wood, while the surface 20 is formed from a foil. Preferably, the decor of the foil at least matches with the image/pattern of the veneer. For example, the foil may simply be made to visually and textually depict the same wood the veneer is made from. Alternatively the surface 16 can be administer such as a direct laminate (DL) or high pressure laminate *HPL) on the T-molding and a foil appears on the other surfaces 20 and/or 20′.

Suitable foils are thin sheets of thermosetting (e.g., melamine formaldehyde) or thermoplastic plastic (e.g., polyvinyl chloride) material having a decorative surface. The decorative surface can be a typically impregnated decor sheet or can be applied directly on the surface of the foil itself, for example, by printing rolling or by a brush. The foil may also take the form of a printed paper, impregnated with, for example, an acrylic resin.

Suitable foils can have an abrasive resistance at least equivalent to AC1, AC2, AC3, AC4 and/or AC5, as defined by the European Laminate Flooring Association. Such foils may also include hard particles to impart abrasion and/or scratch resistance as is known in the art. Suitable hard particles can include alumina, silicon carbide, silicon nitride and diamond, as well as other particles having a Moh's hardness of at least approximately 6, of sizes and distributions known in the art to impart scratch and/or abrasion resistance to similar products. In some embodiment the hardness of the particles may be less than approximately 6, such as 2, 3, 4 or 5 Moh's hardness depending on the desired application and desired properties.

In some embodiments of the invention, it may be desirable to include accent strips which can be integrated with the attachments or even into the T-molding. These accent strips are usually intended for aesthetic purposes, e.g., of a different color or pattern to the wood veneer, natural wood, and/or foil. However, in some instances the intended purpose may be one of visual perception, such as guiding, safety, warning or other condition and may include light reflective particles or tape, may include lights, such as LED's for message, warning, or safety lighting. Additional accent strips or features could have different or the same abrasion ratings, even if identical in pattern or decor.

The invention additionally includes packaging to be used by, for example, wholesalers or retailers. In one embodiment, multiple individual pieces, e.g., T-molding 12, one or more attachments, a securing element 30 and one or more shims 34 may be bundled in a single package or kit. In another embodiment, the package or kit includes two, or three, or even up to twenty or more, of each piece packaged therein. For example, a single package may include three approximately one-meter (or three foot) sections of each item contained therein, for a total length of about three meters (about nine feet). It is additionally within the scope of the invention to include different sets of items in a single package, for example, one set being about one meter (about three feet) long and an additional set being about two meters (about six feet) long.

Additionally, as described herein, the moldings of the invention are designed to be used in the construction and/or assembly of a floor. Such floors can be found in homes (e.g., single family homes, condominiums, and apartment buildings), public establishments (e.g., shopping malls, restaurants, department stores, luxury areas of stadiums and arenas, and other stores), private businesses (reception or other areas of office buildings and warehouses). Utilization of the moldings as described herein provide significant added benefits in cost, performance and installation ease when compared to conventional moldings.

It should be apparent that embodiments other than those specifically described above may come within the spirit and scope of the present invention. Hence, the present invention is not limited by the above description.

We claim:

1. A flooring transition comprising a molding and an attachment thereto said molding including a foot and two generally opposing arms representing the shape of a T; and at least one attachment, the attachment being connected to at least one of the opposing arms or the foot;
said molding having an outer surface presenting at least one decorative surface;
said attachment also having at least one outer decorative surface;
wherein the outer decorative surface of the molding differs in composition from the outer decorative surface of the attachment.

2. The flooring transition according to claim 1, wherein the decorative surface of the attachment comprises an abrasion resistant foil.

3. The flooring transition according to claim 2, wherein the decorative surface of the molding comprises real wood.

4. The flooring transition according to claim 2, wherein the decorative surface of the molding comprises laminate.

5. The flooring transition according to claim 2, wherein the decorative surface of the molding comprises veneer.

6. The flooring transition according to claim 2, wherein the decorative surface of the molding comprises metal.

7. The flooring transition of claim 1, wherein the molding and attachment are joined by a tongue and groove connection.

8. The flooring transition of claim 1, wherein the molding and attachment are joined by an adhesive.

9. A kit comprising the flooring transition of claim 1, and at least one additional attachment, said at least one additional attachment differing in shape from the attachment of the flooring transition.

10. The kit of claim 9, further comprising a securing element.

11. The kit of claim 10, further comprising a shim.

12. The flooring transition of claim 1, further comprising a securing element.

13. The flooring transition of claim 12, wherein the attachment and molding are held in a predetermined spatial relationship by said securing element.

14. The flooring transition of claim 7, wherein there are at least two tongue and groove connections, one between the attachment and at least one of the opposing arms, and one between the foot and the attachment.

15. The flooring transition of claim 7, wherein the tongue and groove connection comprises a tongue on the opposing arm and a groove on the attachment.

16. The flooring transition of claim 2, wherein the foil contains hard particles having a Moh's hardness of at least 6.

17. The flooring transition of claim 2, wherein the foil contains hard particles having a Moh's hardness in the range of 2-6.

18. The flooring transition of claim 1, further comprising an accent strip integrated into at least one of the molding or attachment.

19. The flooring transition of claim 1, further including at least a visual perception element.

20. The flooring transition of claim 1, wherein the visual perception element is a light.
